(19) United States
(12) Patent Application Publication
(10) Pub. No.: US 2019/0354718 A1
(43) Pub. Date: Nov. 21, 2019

(54) IDENTIFICATION OF SENSITIVE DATA USING MACHINE LEARNING

(71) Applicant: MICROSOFT TECHNOLOGY LICENSING, LLC., Redmond, WA (US)

(72) Inventors: DINESH CHANDNANI, SAMMAMISH, WA (US); MATTHEW SLOAN THEODORE EVANS, KINDRED, ND (US); SHENGYU FU, REDMOND, WA (US); GEOFFREY STANEFF, WOODINVILLE, WA (US); EVGENIA STESHENKO, SEATTLE, WA (US); NEELAKANTAN SUNDARESAN, BELLEVUE, WA (US); CENZHUO YAO, KIRKLAND, WA (US); SHAUN MILLER, Sammamish, WA (US)

(21) Appl. No.: 16/413,524

(22) Filed: May 15, 2019

Related U.S. Application Data
(60) Provisional application No. 62/672,173, filed on May 16, 2018.
(60) Provisional application No. 62/672,168, filed on May 16, 2018.

(51) Int. Cl. G06F 21/62; G06F 16/28; G06F 21/60; G06N 20/00; G06Q 30/02

(52) U.S. Cl. CPC G06F 21/6254; G06F 16/285; G06Q 30/0201; G06N 20/00; G06F 21/604

(57) ABSTRACT

An offline batch processing system classifies sensitive data contained in consumer data, such as telemetric data, using a manual classification process and a machine learning model. The machine learning model is used to recheck the policy settings used in the manual classification process and to learn relationships between the features in the consumer data in order to identify sensitive data. The identified sensitive data is then scrubbed so that the remaining data may be used.

### CROSS-REFERENCE TO RELATED APPLICATION

This application claims the benefit of U.S. Provisional Application No. 62/672,173 filed on May 16, 2018 and claims the benefit of U.S. Provisional Application No. 62/672,168 filed on May 16, 2018.

### BACKGROUND

Telemetric data generated during the use of a software product, website, or service (“resource”) is often collected and stored in order to study the performance of the resource and/or the users' behavior with the resource. The telemetric data provides insight into the usage and performance of the resource under varying conditions some of which may not have been tested or considered in its design. The telemetric data is useful to identify causes of failures, delays, or performance problems and to identify ways to improve the customers' engagement with the resource.

The telemetric data may include sensitive data such as the personal information of the user of the resource. The personal information may include a personal identifier that uniquely identifies a user such as, a name, phone number, email address, social security number, login name, account name, machine identifier, and the like. In legacy systems, it may not be possible to alter the collection process to eliminate the collection of the sensitive data.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

An offline batch processing system receives batches of consumer data that may contain sensitive data, such as personal data. The system utilizes a first classification process to identify sensitive data in the consumer data from one or more policies. A second classification process is then used to recheck the non-sensitive data for sensitive data in the previously-labeled non-sensitive data that may have been inadvertently overlooked. The consumer data may include telemetric data, sales data, product reviews, subscription data, feedback data, and other types of data that may contain the personal data of a user. The identified sensitive data is then scrubbed in a sandbox process to obfuscate the sensitive data, eliminate the sensitive data, or convert the sensitive data into non-sensitive data in order for the remaining consumer data to be used for further analysis.

In one aspect, the second classification process is a machine learning technique, such as a classifier trained on features in the consumer data in order to learn the relationships between the features that signify sensitive data. The classifier may be based on a logistic regression model using a Lasso penalty. The features may include words in the consumer data indicative of a field in the consumed data having a higher likelihood of being classified as sensitive data.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF DRAWINGS

FIG. 1 illustrates an exemplary system for scrubbing sensitive data from consumer data.

FIG. 2 is a schematic diagram representing the training of the machine learning model to classify data as sensitive or non-sensitive data.

FIG. 3 is a schematic diagram representing an exemplary aspect of incorporating the machine learning model to detect sensitive data.

FIG. 4 is a flow diagram illustrating an exemplary method for classifying and scrubbing sensitive data from consumer data.

FIG. 5 is a flow diagram illustrating an exemplary method for training and testing the machine learning model.

FIG. 6 is a block diagram illustrating an exemplary operating environment.

### DETAILED DESCRIPTION

Overview

Telemetric data is generated upon the occurrence of different events at different times during a user's engagement with a software product. In order to gain insight into a particular issue with the software product, several different pieces of the telemetric data from different sources may need to be analyzed in order to understand the cause and effect of an issue. The telemetric data may exist in various documents which may be formatted differently containing different fields and properties making it challenging to pull together all the data from a document that is needed to understand an issue.

In some instances, the telemetric data may include sensitive data that needs to be protected against unwarranted disclosure. The sensitive data may be contained in different fields in a document and not always recognizable. In order to more accurately identify the sensitive data, a machine learning model is trained to learn patterns in the data that are indicative of a field containing sensitive data. In one aspect, the machine learning model is a classifier that is trained on patterns of words in an event name, words in a property name, and words in the type of a value of a property in order to identify whether the pattern of words is likely to be considered sensitive data. The machine learning model is used to identify sensitive data that may have been misclassified as non-sensitive data.

Attention now turns to a description of a system for identifying and scrubbing sensitive data.

System

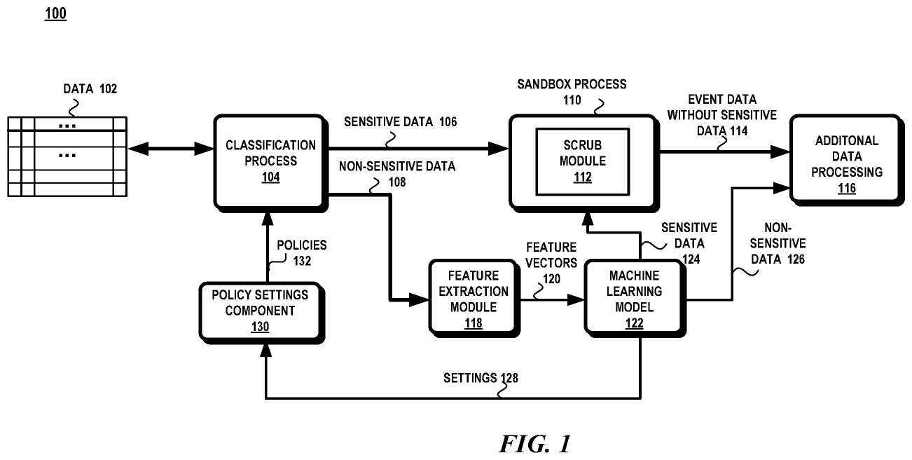

FIG. 1 illustrates a block diagram of an exemplary system 100 in which various aspects of the invention may be practiced. As shown in FIG. 1, system 100 includes a classification process 104 that receives data 102 representing various types of consumer data. Properties in the data 102 may tagged as either sensitive data 106 or non-sensitive data 108 based on policies 132 initially through a classification process 104. The sensitive data 106 is scrubbed from the data 102 in a sandbox process 110 through a scrub module 112. The non-sensitive data 108 is input into a machine learning model 122 that checks whether or not the non-sensitive data 108 has been misclassified. The machine learning model 122 uses features extracted from the non-sensitive data 108 by the feature extraction module 118 to determine whether or not the non-sensitive data 108 should have been classified as sensitive data.

The newly-classified sensitive data 124 is then sent to the sandbox process 110 where it is scrubbed by the scrub module 112. For any newly classified sensitive data 124, the machine learning model 122 outputs the pattern of settings found in the newly classified sensitive data which is then used by the policy settings component 130 to update the classification process 104. The non-sensitive data 126 is forwarded to a downstream process that performs additional processing 116 without the sensitive data.

The data 102 consists of events and additional data related to an event. In one aspect, the data 102 may represent telemetric data generated from the usage of a software product or service. However, it should be noted that the data 102 may include any type of consumer data, such as without limitation, sales data, feedback data, reviews, subscription data, metrics, and the like.

An event may be generated from actions that are performed by an operating system based on a user's interaction with the operating system or resulting from a user's interaction with an application, website, or service executing under the operating system. The occurrence of an event causes event data to be generated such as system-generated logs, measurement data, stack traces, exception information, performance measurements, and the like. The event data may include data from crashes, hangs, user interface unresponsiveness, high CPU usage, high memory usage, and/or exceptions.

The event data may include personal information. The personal information may include one or more personal identifiers that uniquely represents a user and may include a name, phone number, email address, IP address, geolocation, machine identifier, media access control (MAC) address, user identifier, login name, subscription identifier, etc.

In one aspect, the events may arrive in batches and processed offline. The batches are aggregated and formulated into a table. The table may contain different types of event data with different properties. The table has rows and columns A row represents an event and each column may contain a table of properties or fields that describes a specific piece of data that was captured in the event. A property has a value.

Each column represents a property that is tagged with an identifier that classifies the column or property as having sensitive data or non-sensitive data. The classification may be based on policies that indicate whether a combination of event, properties, and/or types of the values of the properties represent sensitive data or non-sensitive data. Based on the classification, a column is tagged as having sensitive data or non-sensitive data. In one aspect, the classification process may be performed manually. In other aspects, the classification may be performed through an automatic process using various software tools or other types of classifiers.

The sensitive data 106 is then scrubbed in a sandbox process 110. A sandbox process 110 is a process that executes in a highly restricted environment with restricted access to resources outside of the sandbox process 110. The sandbox process 110 may be implemented as a virtual machine that runs in isolation from other processes executing in the same machine. The virtual machine is restricted from accessing resources outside of the virtual machine. The sandbox process 110 executes the scrub module 112 which performs action to eliminate the sensitive data so that the rest of the data may be used for additional processing 116. A scrub module 112 may be utilized in the sandbox process 110 to either delete the sensitive data, obfuscate the sensitive data, and/or convert the sensitive data into a non-sensitive or generic value.

The various aspects of the system 100 may be implemented using hardware elements, software elements, or a combination of both. Examples of hardware elements may include devices, components, processors, microprocessors, circuits, circuit elements, integrated circuits, application specific integrated circuits, programmable logic devices, digital signal processors, field programmable gate arrays, memory units, logic gates and so forth. Examples of software elements may include software components, programs, applications, computer programs, application programs, system programs, machine programs, operating system software, middleware, firmware, software modules, routines, subroutines, functions, methods, procedures, software interfaces, application program interfaces, instruction sets, computing code, code segments, and any combination thereof. Determining whether an aspect is implemented using hardware elements and/or software elements may vary in accordance with any number of factors, such as desired computational rate, power levels, bandwidth, computing time, load balance, memory resources, data bus speeds and other design or performance constraints, as desired for a given implementation.

It should be noted that FIG. 1 shows components of the system in one aspect of an environment in which various aspects of the invention may be practiced. However, the exact configuration of the components shown in FIG. 1 may not be required to practice the various aspects and variations in the configuration shown in FIG. 1 and the type of components may be made without departing from the spirit or scope of the invention. For example, classification process 104 may utilized another type of machine learning classifier, such as, without limitation, decision trees, a support vector machine, Naïve Bayes classifier, linear regression, random forest, a k-nearest neighbor algorithm, and the like.

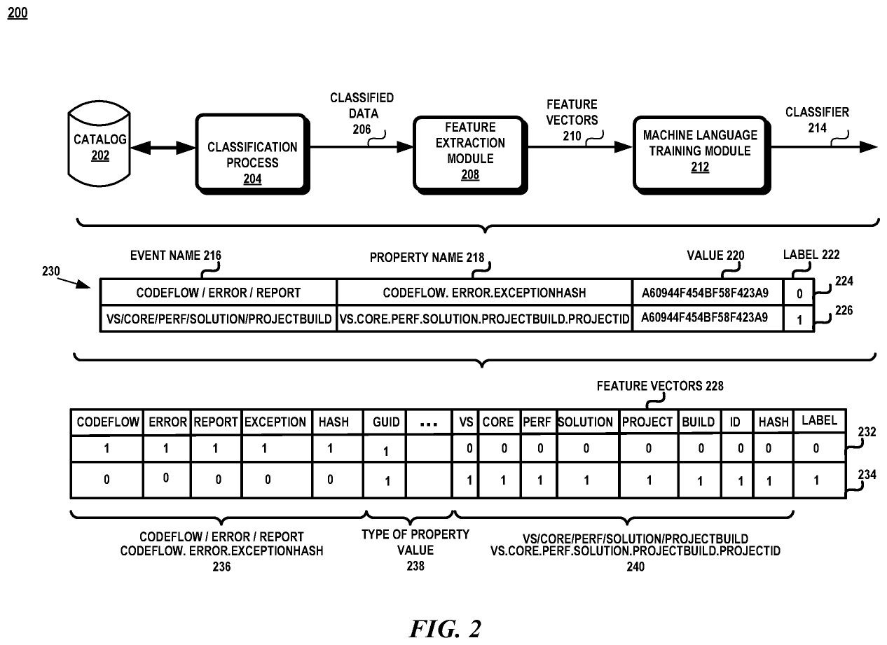

FIG. 2 illustrates an example of training the machine learning model 200. In one aspect, the machine learning model is trained to identify sensitive data within the event data. In one aspect, the machine learning model is a classifier. As shown in FIG. 2, the training includes a source for the training data, such as a catalog 202, a classification process 204, a feature extraction module 208, and a machine learning training module 212.

A catalog 202 is provided that contains a description of the events generated within the system. An event is associated with an event name which describes the source of the event. An event is also associated with properties or fields that describe additional data associated with an event. A property has a value which is mapped into one of the following types: a numeric value (integer, floating point number, boolean), a blank space, a null value, a boolean type (true or false), a 64-bit hash value, an email address, a uniform resource locator (URL), an internet protocol (IP) address, a build number, a local path, and a globally unique identifier (GUID).

Each property within an event in the catalog 202 is classified through a classification process 204 with a label indicating whether the property is considered sensitive or not. For example, a label having the value of ‘1’ indicates that the property contains sensitive data and a label having the value of ‘0’ indicates that the property contains non-sensitive data.

For example, as shown in FIG. 2, table 230 shows data extracted from the catalog 202. The table 230 contains the names codeflow/error/report 224 and vs/core/perf/solution/projectbuild 226 which have been classified by the classification process 204. The event name 216 indicates the event that initiated the collection of the telemetric data. The property name is a particular field associated with that event name The classification process 204 has classified the event 224 with property name codeflow.error.exceptionhash and value A60944F454BF58F423A9 with a label of 0, which indicates that this property is not sensitive data. The classification process has classified event 226, vs/core/perf/solution/projectbuild, which has property name vs.core.perf.solution.projectbuild.projectid with value A60944F454BF58F423A9 with the label of a value 1, which indicates that this property is sensitive data.

The feature extraction module 208 extracts each word in the event name, the property name, and the type of the value of the property for each event in the catalog 202. These words are used as features. For example, the words codeflow, error and report are extracted from the event name codeflow/error/report, the words codeflow, error, exception, and hash are extracted as features from the property name, and the word GUID is extracted as a feature since GUID is the type of the value of a property. Similarly, the words vs, core, perf, solution, project, and build are extracted from the event name vs/core/perf/solution/projectbuild, the words vs, core, perf, solution, project, build, and id are extracted from the property name vs. core.perf. solution.projectbuild.projectid, and the word GUID is extracted from the type of the value of the property.

The feature extraction module 208 extracts the words from each event name, each property name, each type of the property value and each label to generate feature vectors 228 to train the classifier 214. As shown in FIG. 2, there is a feature vector 232 for the codeflow/error/report event name and the codeflow.error.exceptionhash property name and a feature vector 234 for the vs/core/perf/solution/projectbuild event name and the vs.core.perfsolution.projectbuild.projectid property name. The feature vectors have an entry for the type of the value 238 corresponding to a property name A feature vector contains a sequence of bits representing respective words in the event name, property name, and type of the property value and the classification label.

The feature vectors 228 are then input into a machine learning training module 212 to train the classifier 214 to detect when a sequence of bits representing a combination of words in the event name, property name, and type of property value indicate sensitive data. When the classifier 214 is train sufficiently, it is used to classify data that may have been mistakenly classified as non-sensitive data.

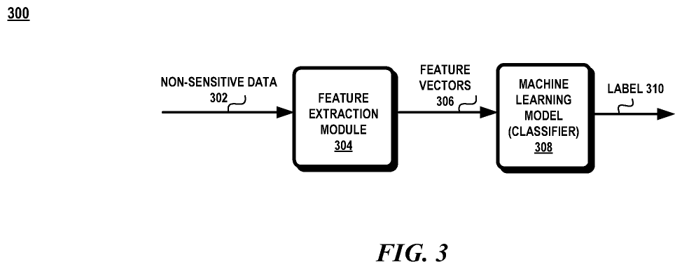

FIG. 3 illustrates an exemplary system 300 utilizing the classifier 308. Data previously classified as non-sensitive data 302 is input to the feature extraction module 304 to extract features. The features include the words in the event name, the words in the property name, and the words of the type of property value. The features are embedded into a feature vector 306 which is input into the classifier 308. There is no label in the feature vector. The output of the classifier 308 is a label 310 indicating whether the previously-classified non-sensitive data is to be considered sensitive data or not. The settings used in the feature vector for the data that is reclassified by the classifier as containing sensitive data is sent to the policy settings component 130. The policy settings component 130 updates the policies to include the newly discovered pattern that represents sensitive data. The newly discovered pattern includes the combination of words in the event name, property name, and type of property value.

Methods

Attention now turns to description of the various exemplary methods that utilize the system and device disclosed herein. Operations for the aspects may be further described with reference to various exemplary methods. It may be appreciated that the representative methods do not necessarily have to be executed in the order presented, or in any particular order, unless otherwise indicated. Moreover, various activities described with respect to the methods can be executed in serial or parallel fashion, or any combination of serial and parallel operations. In one or more aspects, the method illustrates operations for the systems and devices disclosed herein.

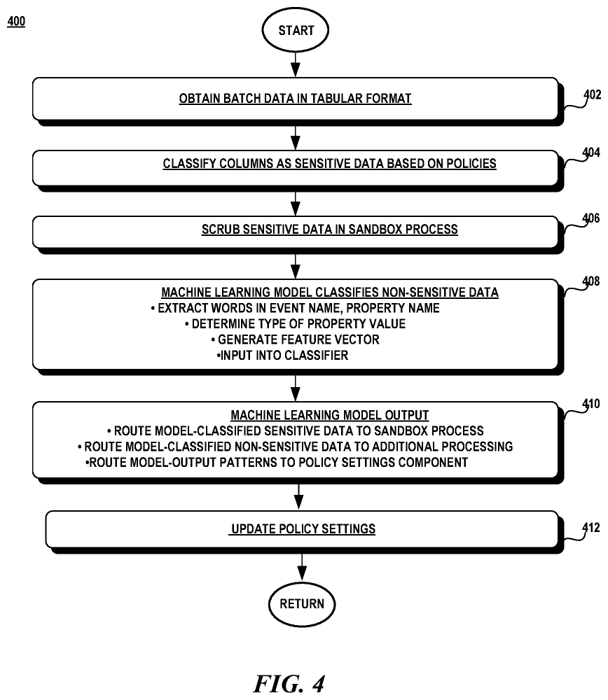

FIG. 4 illustrates an exemplary method 400 for scrubbing sensitive data. Referring to FIGS. 1 and 4, data arrives in batches in a tabular format (block 402). A classification process 104 analyzes each property in a column and decides whether to classify a column as containing sensitive data based on the policies 132. A column represents a property name and contains a value. The policies 132 indicate the combination of words that are indicative of a column being classified as sensitive data (block 404). The identified sensitive data is scrubbed in a sandbox environment (block 406). A scrub module 124 may delete the sensitive data, obfuscate the sensitive data using various hashing techniques, and/or convert the data to a non-sensitive value (block 406).

The non-sensitive data 108 is then input into the classifier 122 to check for any possible misclassifications. Features are extracted through the feature extraction module 118 and input into the classifier 122 which outputs a label indicating whether the previously classified data should be non-sensitive data 126 or sensitive data 124 (block 408). Data that the classifier determines to be non-sensitive data is then routed to the additional data processing 116 and data that the classifier determines is sensitive data 124 is then routed to the sandbox process 110 (block 410). The classifier 122 also outputs the settings of each feature that was used to reclassify the data (block 410). The policy settings component 130 uses the settings to update the policies 132 (block 412).

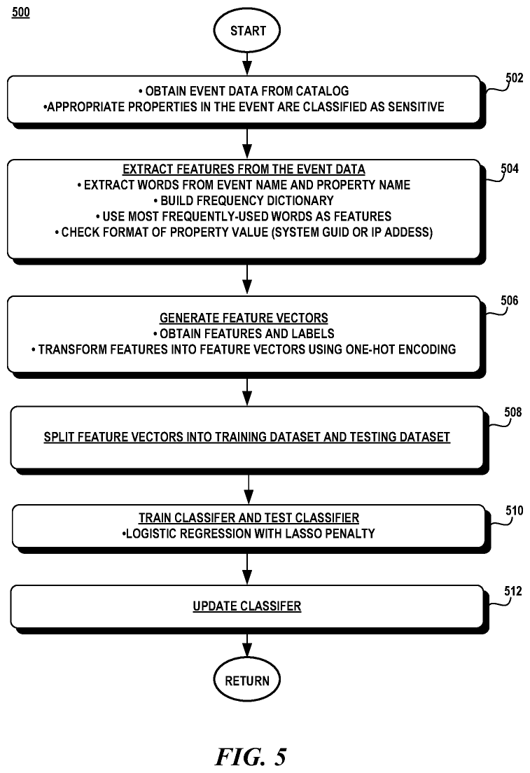

FIG. 5 illustrates an exemplary method 500 for training the classifier. Turning to FIGS. 2 and 5, event data is obtained from a catalog 202 that contains a listing of all the types of event data existing in a system. The event data includes an event name and one or more property names. The property names contain values that are classified into various types. The types of a property value may include blank, null, true/false, 64-bit hash, email, GUID, zero/one, integer, URL, URL_IP, build number, IP address, float, or local path. A classification process 204 identifies which property names and values of a particular event are considered sensitive data. (Collectively, block 502).

The feature extraction module 208 extract features from the event data. The feature extraction module 208 extracts words used in the event name, property name, and name of the type of property value as features. The frequency of the extracted words is kept in a frequency dictionary. In order to control the length of the feature vector, the most-frequently used words are used in the feature vector and the less-frequently used words are discarded. The feature extraction module 208 also checks the format of the property value to determine the type of the property value, such as GUID or IP address. (Collectively, block 504).

Feature vectors are generated for the extracted features which contain the label. The feature vectors are transformed into binary values through one-hot encoding. One-hot encoding converts categorical data into numerical data. (Collectively, block 506).

The feature vectors are split into a training dataset and a testing dataset. In one aspect, 80% of the feature vectors are used as the training dataset and the remaining 20% are used as the testing dataset. (Collectively, block 508).

The training dataset is then used to train the classifier. The training dataset is used by the classifier to learn relationships between the feature vectors and the label. In one aspect, the classifier is trained using logistic regression having a Least Absolute Shrinkage and Selection Operator (Lasso) penalty. Logistic regression is a statistical technique for analyzing a dataset where there are multiple independent variables that determine a dichotomous outcome (i.e., label=‘1’ or ‘0’). The goal of logistic regression is to find the best fitting model to describe the relationship between the independent variables (i.e., features) and the characteristic of interest (i.e., label). Logistic regression generates the coefficients of a formula to predict a logit transformation of the probability of the presence of the outcome as follows:

logit(p)=b₀+b₁X₁+b₂X₂+ . . . +bₖXₖ, where p is the probability of the presence of the characteristic of interest. The logit transformation is defined as the logged odds:

$$odds = \frac{p}{1 - p} = \frac{probability of presence of characteristic}{probability of absence of characteristic} and logit ( p ) = ln ( \frac{p}{1 - p} ) .$$

Estimation in logistic regression chooses parameters that maximize the likelihood of observing the sample values by maximizing a log likelihood function with a normalizing factor, which is maximized using an optimization technique such as gradient descent. A Lasso penalty term is added to the log likelihood function to reduce the magnitude of the coefficients that contribute to a random error by setting these coefficients to zero. The Lasso penalty is used in this case since there are a large number of variables where there is a tendency for the model to overfit. Overfitting occurs when the model describes the random error in the data rather than the relationships between the variables. With the Lasso penalty, coefficients of some parameters get reduced to zero, making the model less likely to overfit and it reduces the size of model by removing unimportant features. This process also expedites the model application time as the features are further optimized. (Collectively, block 510).

When the model is fixed, the model is then tested with the training dataset to prevent the model from overfitting. If the accuracy of the model is within a threshold (e.g., 2%) of the difference between the training dataset and the testing dataset, the classifier is ready for production. (Collectively, block 510).

The model may be updated with new training data periodically. New telemetric data may arrive or new event data may be added to the catalog warranting the need to retrain the classifier. In this case, the process (blocks 502-510) is reiterated to generate an updated classifier. (Collectively, block 512).

Exemplary Operating Environment

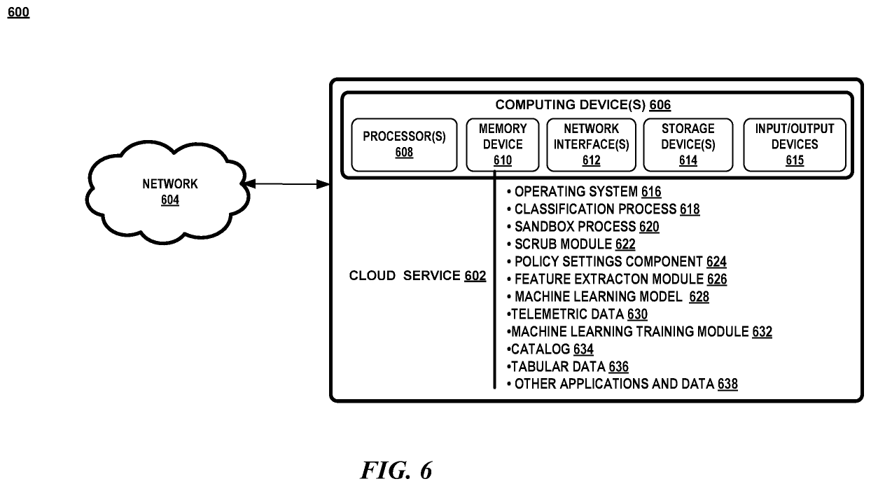

Attention now turns to a discussion of an exemplary operating embodiment. FIG. 6 illustrates an exemplary operating environment 600 that includes one or more computing devices 606. The computing devices 606 may be any type of electronic device, such as, without limitation, a mobile device, a personal digital assistant, a mobile computing device, a smart phone, a cellular telephone, a handheld computer, a server, a server array or server farm, a web server, a network server, a blade server, an Internet server, Internet of Things (IoT) device, a work station, a mini-computer, a mainframe computer, a supercomputer, a network appliance, a web appliance, a distributed computing system, multiprocessor systems, or combination thereof. The operating environment 600 may be configured in a network environment, a distributed environment, a multi-processor environment, or a stand-alone computing device having access to remote or local storage devices.

The computing devices 606 may include one or more processors 608, at least one memory device 610, one or more network interfaces 612, one or more storage devices 614, and one or more input and output devices 615. A processor 608 may be any commercially available or customized processor and may include dual microprocessors and multi-processor architectures. The network interfaces 612 facilitate wired or wireless communications between a computing device 606 and other devices. A storage device 614 may be a computer-readable medium that does not contain propagating signals, such as modulated data signals transmitted through a carrier wave. Examples of a storage device 614 include without limitation RAM, ROM, EEPROM, flash memory or other memory technology, CD-ROM, digital versatile disks (DVD), or other optical storage, magnetic cassettes, magnetic tape, magnetic disk storage, all of which do not contain propagating signals, such as modulated data signals transmitted through a carrier wave. There may be multiple storage devices 614 in a computing device 606.

The input/output devices 615 may include a keyboard, mouse, pen, voice input device, touch input device, display, speakers, printers, etc., and any combination thereof.

The memory device 610 may be any non-transitory computer-readable storage media that may store executable procedures, applications, and data. The computer-readable storage media does not pertain to propagated signals, such as modulated data signals transmitted through a carrier wave. It may be any type of non-transitory memory device (e.g., random access memory, read-only memory, etc.), magnetic storage, volatile storage, non-volatile storage, optical storage, DVD, CD, floppy disk drive, etc. that does not pertain to propagated signals, such as modulated data signals transmitted through a carrier wave. The memory 610 may also include one or more external storage devices or remotely located storage devices that do not pertain to propagated signals, such as modulated data signals transmitted through a carrier wave.

The memory device 610 may contain instructions, components, and data. A component is a software program that performs a specific function and is otherwise known as a module, program, engine, component, and/or application. The memory 610 may contain an operating system 616, a classification process 618, a sandbox process 620, a scrub module 622, a policy settings component 624, a feature extraction module 626, a machine learning model 628, telemetric data 630, a machine learning training module 632, a catalog 634, tabular data 636, and other applications and data 638.

Conclusion

A system is disclosed having one or more processors and a memory. The system also includes one or more programs, wherein the one or more programs are stored in the memory and are configured to be executed by the one or more processors. The one or more programs including instructions that: classify customer data through a first classification process, the first classification process indicating whether a segment of the customer data includes sensitive data or non-sensitive data, the segment associated with a first name and second name, the first name associated with a source of the customer data and the second name associated with a field in the customer data; when the first classification process classifies the customer data as having non-sensitive data, utilize a machine learning classifier to determine, from the first name and the second name, if the segment of customer data classified as having non-sensitive data, is sensitive data; and when the machine learning classifier classifies the segment of customer data as containing sensitive data, scrub the sensitive data from the customer data.

The machine learning classifier uses words in the first name, words in the second name, and words representing a type of a value of the property to classify the segment of the customer data. In another aspect, the one or more programs include further instructions that: when the first classification process classifies the customer data as containing sensitive data, scrub the sensitive data from the customer data. Yet in another aspect, the one or more programs include further instructions that generate a sandbox process to scrub the sensitive data. In another aspect, the one or more programs include further instructions that: extract features from the customer data, the features including words in the first name, words in the second name and words that describe a type of a value associated with the second name; and generate a feature vector including the extracted features to input into the machine learning classifier.

In other aspects, the one or more programs include further instructions that: generate a policy based on the extracted features; and wherein the first classification process uses the policy to detect sensitive data. The machine learning classifier is trained using logistic regression with a Lasso penalty. Other aspects include further instructions that: when the machine learning classifier classifies the customer data as not containing sensitive data, the customer data is utilized for further analysis.

A method is disclosed comprising: obtaining customer data including at least one property considered non-sensitive data; extracting features from the customer data including words in a name associated with the at least one property, words in a name associated with an event initiating the customer data, and a type of a value of the at least one property; classifying, through a machine learning classifier, the at least one property as sensitive data based on the extracted features; and scrubbing a value of the at least one property from the customer data.

In one aspect, the method further comprises: training the machine learning classifier using logistic regression function with a Lasso penalty. In another aspect, the method further comprises: prior to obtaining the customer data, classifying through a first classification process, the at least one property as non-sensitive data. In one or more aspects, the first classification process uses one or more policies to classify a property as sensitive data, where a policy is based on a combination of words in usage patterns of identified sensitive data. In another aspect, the method comprises generating a new policy based on the extracted features. Other aspects include generating a sandbox in which the value of the at least one property is scrubbed from the customer data. The scrubbing includes one or more of obfuscating the value of the at least one property, deleting the value of the at least one property, or converting the value of the at least one property to a non-sensitive value.

A device is disclosed having at least one processor and a memory. The at least one processor configured to: obtain a plurality of training data, the training data including an event name and one or more properties, a property associated with a property name and a value, the event name describing an event triggering collection of consumer data; classify each property of each event name of the plurality of training data with a label; and train a classifier with the plurality of training data to associate a label with words extracted from an event name and a property name of consumer data, where the label indicates whether the property name of the consumer data represents personal data or non-personal data.

The classifier may be trained through logistic regression using a Lasso penalty. The features include words describing a type of a value associated with a property. The features may include words most frequently found in the training data. In one or more aspects, classify each property of each event name of the plurality of training data with a label is performed using a decision tree, support vector machine, Naïve Bayes classifier, random forest, or a k-nearest neighbor technique.

Although the subject matter has been described in language specific to structural features and/or methodological acts, it is to be understood that the subject matter defined in the appended claims are not necessarily limited to the specific features or acts described above. Rather, the specific features and acts described above are disclosed as example forms of implementing the claims.

What is claimed:

1. A system, comprising:
one or more processors; and a memory;
one or more programs, wherein the one or more programs are stored in the memory and are configured to be executed by the one or more processors, the one or more programs including instructions that:
classify customer data through a first classification process, the first classification process indicating whether a segment of the customer data includes sensitive data or non-sensitive data, the segment associated with a first name and second name, the first name associated with a source of the customer data and the second name associated with a field in the customer data;
when the first classification process classifies the customer data as having non-sensitive data, utilize a machine learning classifier to determine, from the first name and the second name, if the segment of customer data classified as having non-sensitive data, is sensitive data; and
when the machine learning classifier classifies the segment of customer data as containing sensitive data, scrub the sensitive data from the customer data.

2. The system of claim 1, wherein the machine learning classifier uses words in the first name, words in the second name, and words representing a type of a value of the property name to classify the segment of customer data.

3. The system of claim 1, wherein the one or more programs include further instructions that:
when the first classification process classifies the customer data as containing sensitive data, scrub the sensitive data from the customer data.

4. The system of claim 1, wherein the one or more programs include further instructions that generate a sandbox process to scrub the sensitive data.

5. The system of claim 1, wherein the one or more programs include further instructions that:
extract features from the customer data, the features including words in the first name, words in the second name and words that describe a type of a value associated with the second name; and
generate a feature vector including the extracted features to input into the machine learning classifier.

6. The system of claim 5, wherein the one or more programs include further instructions that:
generate a policy based on the extracted features; and
wherein the first classification process uses the policy to detect sensitive data.

7. The system of claim 1, wherein the machine learning classifier is trained using logistic regression with a Lasso penalty.

8. The system of claim 1, wherein the one or more programs include further instructions that:
when the machine learning classifier classifies the customer data as not containing sensitive data, utilizing the customer data for further analysis.

9. A method, comprising:
obtaining customer data including at least one property considered non-sensitive data;
extracting features from the customer data including words in a name associated with the at least one property, words in a name associated with an event initiating the customer data, and a type of a value of the at least one property;
classifying, through a machine learning classifier, the at least one property as sensitive data based on the extracted features; and
scrubbing a value of the at least one property from the customer data.

10. The method of claim 9, further comprising:
training the machine learning classifier using logistic regression function with a Lasso penalty.

11. The method of claim 9, further comprising:
prior to obtaining the customer data, classifying through a first classification process, the at least one property as non-sensitive data.

12. The method of claim 11, wherein the first classification process uses one or more policies to classify a property as sensitive data, a policy based on a combination of words in usage patterns of identified sensitive data.

13. The method of claim 12, further comprising:
generating a new policy based on the extracted features.

14. The method of claim 9, further comprising:
generating a sandbox in which the value of the at least one property is scrubbed from the customer data.

15. The method of claim 9, wherein the scrubbing includes one or more of obfuscating the value of the at least one property, deleting the value of the at least one property, or converting the value of the at least one property to a non-sensitive value.

16. A device, comprising:
at least one processor and a memory;
the at least one processor configured to:
obtain a plurality of training data, the training data including an event name and one or more properties, a property associated with a property name and a value, the event name describing an event triggering collection of consumer data;
classify each property of each event name of the plurality of training data with a label; and
train a classifier with the plurality of training data to associate a label with words extracted from an event name and a property name of consumer data, wherein the label indicates whether the property name of the consumer data represents personal data or non-personal data.

17. The device of claim 16, wherein the classifier is trained through logistic regression using a Lasso penalty.

18. The device of claim 16, wherein the features include words describing a type of a value associated with a property name.

19. The device of claim 16, wherein the features include words most frequently found in the training data.

20. The device of claim 16, wherein classify each property of each event name of the plurality of training data with a label is performed using machine learning techniques that include decision trees, support vector machine, naïve bayes, a random forest, or k-means.
